(19) United States
(12) Patent Application Publication
(10) Pub. No.: US 2022/0284062 A1
(43) Pub. Date: Sep. 8, 2022

(54) INFORMATION PROVIDING APPARATUS, INFORMATION PROVIDING METHOD, AND NON-TRANSITORY STORAGE MEDIUM

(71) Applicant: NEC Corporation, Tokyo (JP)

(72) Inventors: Keisuke IKEDA, Tokyo (JP); Kazufumi Kojima, Tokyo (JP); Masahiro Tani, Tokyo (JP)

(73) Assignee: NEC Corporation, Tokyo (JP)

(21) Appl. No.: 17/677,112

(22) Filed: Feb. 22, 2022

(30) Foreign Application Priority Data
Mar. 3, 2021 (JP) 2021-033236

(51) Int. Cl. G06F 16/951; G06F 16/9538; G06F 16/9537; G06V 20/52; G06V 20/00

(52) U.S. Cl. CPC G06F 16/951; G06F 16/9538; G06F 16/9537; G06V 20/53; G06V 20/35

(57) ABSTRACT

To provide a sufficient amount of information and increase a degree of satisfaction of a user in a technique for providing information specified for a community. According to the present invention, an information providing apparatus 10 including a post-information acquisition unit 11 that acquires post information including a post content posted on the Internet and position information, a sensor-information acquisition unit 12 that acquires sensor information including data generated by a sensor and installation position information of the sensor, a section-information generation unit 13 that generates, based on the post information and the sensor information, section information relating to each of a plurality of observation sections, and an output unit 14 that outputs the section information, is provided.

### TECHNICAL FIELD

The present invention relates to an information providing apparatus, an information providing method, and a program.

### BACKGROUND ART

Patent Document 1 discloses an information sharing system that discloses information specified for a community. The information sharing system discloses information registered by an information provider and discloses information generated by a sensor.

Non-Patent Documents 1 to 3 describes in detail a hotness index relating to a degree of danger in heat illness.

### RELATED DOCUMENT

### Patent Document

[Patent Document 1] Japanese Patent Application Publication No. 2013-214905

### Non-Patent Document

[Non-Patent Document 1] Ministry of the Environment, “Heat Illness Prevention Information Site -Detailed Explanations of Wet Bulb Globe Temperature (WBGT)-”,[online], [searched on Dec. 4, 2020], Internet<URL:https://www.wbgtenv.go.jp/doc_observation.php>

[Non-Patent Document 2] Ministry of the Environment, “Heat Illness Prevention 3 0 Information Site -Detailed Explanations of -All about Wet Bulb Globe Temperature (WBGT)-”,[online], [searched on Dec. 4, 2020], Internet<URL:https://www.wbgt.env.go.jp/wbgt_lp.php>

[Non-Patent Document 3] Industrial Health Division, Safety and Health Department, Labour Standards Bureau, Ministry of Health, Labour, and Welfare, “Let's Prevent Heat Illness”, [online], [searched on Dec. 4, 2020], Internet<URL:https://www.wbgt.env.go.jp/pdf/ic_rma/2301/mat_05_3.pdf>

### DISCLOSURE OF THE INVENTION

### Technical Problem

In a case of “a means for disclosing information registered by an information provider” disclosed in Patent Document 1, when a frequency of registrations is small, information provided to a user decreases, and therefore a degree of satisfaction of a user decreases. In a technique for providing information specified for a community, a registrant of information is limited to a person related to the community, and therefore it may be difficult to increase a frequency of registrations.

Further, in a case of “a means for disclosing information generated by a sensor” disclosed in Patent Document 1, when the installation number of sensors is small, a place of which information is disclosed is limited, and therefore a degree of satisfaction of a user decreases. It may be difficult to install, in view of cost, maintenance after installation, and the like, a sensor in such a way as to cover all places in a community.

An issue according to the present invention is to provide, in a technique for providing information specified for a community, a sufficient amount of information and increase a degree of satisfaction of a user.

### Solution to Problem

According to the present invention,

provided is an information providing apparatus including:

a post-information acquisition means for acquiring post information including a post content posted on the Internet and position information;

a sensor-information acquisition means for acquiring sensor information including data generated by a sensor and installation position information of the sensor;

a section-information generation means for generating, based on the post information and the sensor information, section information relating to each of a plurality of observation sections; and

an output means for outputting the section information.

Further, according to the present invention,

provided is an information providing method including:

by a computer,

acquiring post information including a post content posted on the Internet and position information;

acquiring sensor information including data generated by a sensor and installation position information of the sensor;

generating, based on the post information and the sensor information, section information relating to each of a plurality of observation sections; and

outputting the section information.

Further, according to the present invention,

provided is a program causing a computer to function as:

a post-information acquisition means for acquiring post information including a post content posted on the Internet and position information;

a sensor-information acquisition means for acquiring sensor information including data generated by a sensor and installation position information of the sensor;

a section-information generation means for generating, based on the post information and the sensor information, section information relating to each of a plurality of observation sections; and

an output means for outputting the section information.

Further, according to the present invention,

provided is an information providing apparatus including:

a section-information generation means for generating, based on a post content that includes position information and is posted on the Internet and sensor information including data generated by a sensor and installation position information of the sensor, section information relating to each of a plurality of observation sections; and

an output means for outputting an image where the section information is mapped on a map.

### Advantageous Effects of the Invention

According to the present invention, in a technique for providing information specified for a community, a sufficient amount of information is provided, and thereby a degree of satisfaction of a user can be increased.

### BRIEF DESCRIPTION OF THE DRAWINGS

FIG. 1 is a diagram illustrating one example of a hardware configuration of an information providing apparatus according to a present example embodiment.

FIG. 2 is a diagram illustrating one example of a function block diagram of the information providing apparatus according to the present example embodiment.

FIG. 3 is a diagram for illustrating one example of an observation section according to the present example embodiment.

FIG. 4 is a flowchart illustrating one example of a flow of processing of the information providing apparatus according to the present example embodiment.

FIG. 5 is a diagram for illustrating an advantageous effect of the information providing apparatus according to the present example embodiment.

FIG. 6 is a diagram for illustrating an advantageous effect of the information providing apparatus according to the present example embodiment.

FIG. 7 is a diagram illustrating one example of a function block diagram of the information providing apparatus according to a present example embodiment.

### DESCRIPTION OF EMBODIMENTS

Hereinafter, example embodiments according to the present invention are described by using the accompanying drawings. Note that, in all the drawings, a similar component is assigned with a similar reference sign, and description thereof is omitted, as appropriate.

<First Example Embodiment>

### “Outline”

An information providing apparatus according to the present example embodiment acquires, as information related to a community, “a post content posted on the Internet” and “data generated by a sensor installed in the community”. Then, the information providing apparatus generates new information by combining the acquired post content and sensor data and outputs the generated information to a user.

When only acquired information is merely output to a user as acquired, an amount of information being possible to be output is limited to an amount of acquired information. In contrast, when a plurality of types of information are acquired and new information is generated by combining these pieces of information, information can be output beyond an amount of acquired information. For example, a situation of a position undetectable by a sensor is predicted based on data of a peripheral sensor and a post content, and thereby information of the position undetectable by the sensor can be complemented. As a result, information of every place in a community can be disclosed. Further, a situation of a position undetectable by a sensor is predicted based on a plurality of pieces of information such as data of a peripheral sensor and a post content, and thereby information with higher reliability can be complemented. As a result, information excellent in not only amount but also quality is provided, and thereby a degree of satisfaction of a user can be increased.

### “Function Configuration”

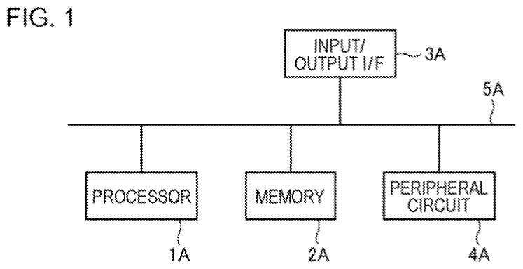

Next, a configuration of the information providing apparatus is described in detail. First, one example of a hardware configuration of the information providing apparatus is described. FIG. 1 is a diagram illustrating a hardware configuration example of the information providing apparatus. Each function unit included in the information providing apparatus can be achieved by any combination of hardware and software, mainly including a central processing unit (CPU) of any computer, a memory, a program loaded on a memory, a storage unit (capable of storing, in addition to a program previously stored from a stage of shipping an apparatus, even a program downloaded from a storage medium such as a compact disc (CD), a server on the Internet, and the like) such as a hard disk storing the program, and an interface for network connection. Then, it is understandable to those of ordinary skill in the art that there are various modified examples with respect to an achievement method and an apparatus therefor.

As illustrated in FIG. 1, the information providing apparatus includes a processor 1A, a memory 2A, an input/output interface 3A, a peripheral circuit 4A, and a bus 5A. The peripheral circuit 4A includes various modules. The information providing apparatus may not necessarily include the peripheral circuit 4A. Note that, the information providing apparatus may be configured by using a plurality of apparatuses being physically and/or logically divided, or may be configured by using a single apparatus united physically and/or logically. In the former case, each of a plurality of apparatuses configuring each apparatus may include the above-described hardware configuration.

The bus 5A is a data transmission path where the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A issues an instruction to each module, and thereby can perform an arithmetic operation, based on an operation result thereof.

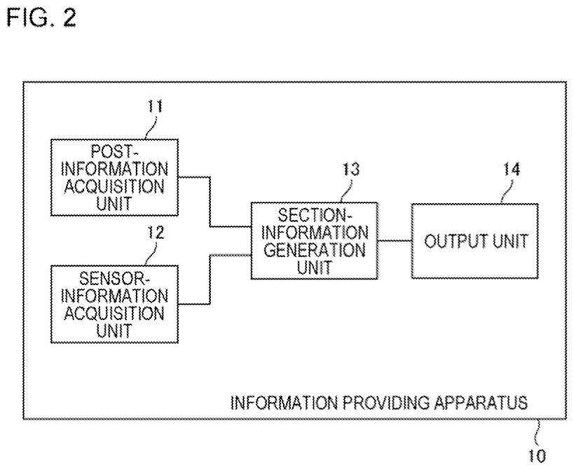

FIG. 2 illustrates one example of a function block diagram of an information providing apparatus 10. As illustrated, the information providing apparatus 10 includes a post-information acquisition unit 11, a sensor-information acquisition unit 12, a section-information generation unit 13, and an output unit 14.

The post-information acquisition unit 11 acquires post information including a post content posted on the Internet and position information. The post information may further include information indicating a post timing (a time and date, and the like).

The post content is text data, an image (a still image or a moving image), and the like. The post-information acquisition unit 11 acquires a post content posted. for example, on social media, a social networking service (SNS), a home page of an entity related to a community, and the like.

The position information is information indicating a position (a position for a current or past stay) of a contributor, a destination to be headed to from now, and the like. The post-information acquisition unit 11 may acquire position information indicating, for example, a post position included in metadata (a geotag or the like) of a post content. Further, the post-information acquisition unit 11 may acquire position information indicating an image-capturing position included in metadata of an image acquired as a post content. Further, the post-information acquisition unit 11 may determine, based on a background of an image acquired as a post content, an image-capturing position of the image, and acquire the determined image-capturing position as position information. Further, the post-information acquisition unit 11 may extract, from among pieces of text data acquired as a post content, a word (an address, a geographical name, a facility name, or the like) relating to a position, and acquire a word relating to the extracted position as position information. Note that, the post-information acquisition unit 11 analyzes wording of text data acquired as a post content, and thereby can estimate whether position information acquired based on the above-described method indicates any of a current position, a past position, and a destination to be headed to from now.

The sensor-information acquisition unit 12 acquires sensor information including data generated by a sensor and installation position information of the sensor. The sensor information may further include information indicating a timing (a time and date, and the like) at which data are generated. The sensor may be a sensor installed in a community to be observed, or may be a sensor included in a terminal (a smartphone, a smartwatch, a tablet terminal, a mobile game machine, a mobile phone, a car navigation system, and the like) held by a user.

The sensor includes at least one of an image sensor that generates an image, a temperature sensor that generates temperature data, a humidity sensor that generates humidity data, an illuminance sensor that generates illuminance data, a wind velocity sensor that generates wind velocity data, a surveillance sensor that generates data indicating an operation status of an air conditioner, a sensor that is installed in an automobile or on a road and generates probe information (a traffic amount and velocity), a sensor that acquires route information set in a car navigation system, a sensor (a beacon or a GPS sensor) that generates position information of a person and acceleration information, a microphone that acquires an environmental sound, a sound based on traffic of a person, and the like. As a camera being one example of the sensor, a visible-light camera, an infra-red camera, and a stereo camera are exemplified. The camera may be a camera that acquires two-dimensional image information, or may be a camera that acquires, in addition to two-dimensional image information, depth information. The sensor continues generating data. Note that, an image generated by an image sensor may be a moving image, or may be a plurality of still images generated repeatedly at a predetermined time interval.

The sensor-information acquisition unit 12 acquires data generated by a sensor installed in a community to be observed. The sensor-information acquisition unit 12 may acquire data generated by a sensor, based on real-time processing via any communication network. Further, the sensor-information acquisition unit 12 may acquire data generated by a sensor, based on batch processing by using any method. Whether to employ any one of the methods can be determined according to a content and the like of section information (information generated by the section-information generation unit 13) provided to a user. As a community to be observed, one ward, city, or town, one shopping street, one theme park, one station, one street, one large-scale commercial facility, one airport, one platform, one leisure facility, one sports facility, and one stadium are exemplified without limitation thereto.

The section-information generation unit 13 generates, based on post information and sensor information, section information relating to each of a plurality of observation sections.

First, a plurality of observation sections are described. According to the present example embodiment, a plurality of observation sections are set in a community to be observed. While there are various ways for the setting, one example is described below.

### —Observation Section Setting Example 1—

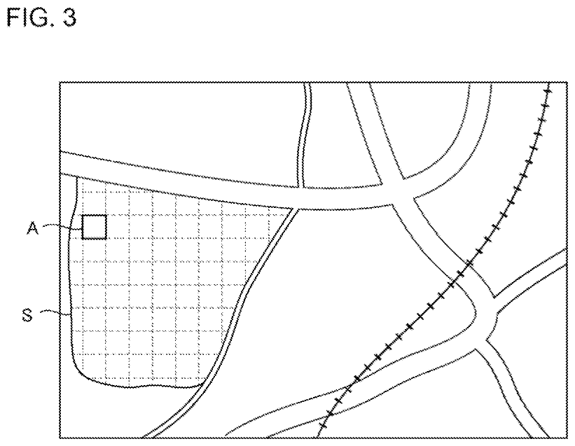

In the present example, as illustrated in FIG. 3, a community S to be observed is divided into a plurality of sections (sections divided by vertical and horizontal dotted lines). Then, all sections may be set as an observation section A, or some sections extracted, based on any method, from among a plurality of sections may be set as the observation section A. A method of dividing the community S to be observed into a plurality of sections is not specifically limited and every method is employable. As a size of a section is decreased, information having finer granularity can be provided. On the other hand, as a size of a section is decreased, a processing load on a computer is increased, and further, in order to cause pieces of section information of a plurality of sections to be different from each other, a problem in that more sensors are required is produced. Based on required performance, a situation of an available resource, and the like, it can be determined how large a section is.

### —Observation Section Setting Example 2—

In the present example, an observation section is set based on a facility unit existing in a community to be observed. In other words, all or some of facilities existing in a community to be observed are set as an observation section. One example of a facility includes a store, a station, a city, a street, a large-scale commercial facility, an airport, a terminal station, a platform, a leisure facility, a sports facility, a stadium, and the like.

Next, section information is described. The section information is information indicating a situation of each observation section. A situation of each observation section indicated by the section information includes, but not limited to, for example, a congestion situation of each observation section, a prediction result of a future congestion situation of each observation section, a degree of danger in heat illness of each observation section, and the like.

The section information of each observation section is generated based on at least one of “data of each observation section generated by a sensor”, “data of another observation section related to each observation section generated by a sensor”, “post information related to a community to be observed”, and “another piece of information”.

“Data of each observation section generated by a sensor” are data generated by a camera installed in such a way as to image-capture an inside of each observation section, data generated by a sensor installed in each observation section, and the like.

“Data of another observation section related to each observation section generated by a sensor” are data generated by a camera installed in such a way as to image-capture an inside of another observation section related to each observation section, data generated by a sensor installed in another observation section related to each observation section, and the like. “Another observation section related to each observation section” is an observation section having a predetermined position relation with each observation section, and, for example, an observation section adjacent to each observation section, an observation section where a distance (a shortest distance or the like) to each observation section is equal to or less than a threshold, and the like are exemplified.

“Post information related to a community to be observed” is post information including position information related to a community to be observed. Position information related to a community to be observed is position information indicating a position in a community to be observed.

“Another piece of information” is information other than the above-described exemplified pieces of information related to a community to be observed. Details thereof are described according to the following example embodiments.

The section-information generation unit 13 combines the plurality of pieces of above-described data, and generates section information such as a congestion situation of each observation section, a prediction result of a future congestion situation of each observation section, and a degree of danger in heat illness of each observation section. Note that, details thereof are described according to the following example embodiments.

The output unit 14 outputs section information of each of a plurality of observation sections generated by the section-information generation unit 13.

As one example, the output unit 14 can output an image where section information is mapped on a map. The output unit 14 may display, in an image as illustrated in FIG. 3, a color of each observation section A, for example, by using a color according to a situation (a congestion situation, a future congestion situation, a degree of danger in heat illness, or the like) of each observation section A. In addition, the output unit 14 may display, in an image as illustrated in FIG. 3, a mark, a character, a number, or the like according to a situation of each observation section A in association with each observation section A. In addition, the output unit 14 may screen-display, when receiving, in an image as illustrated in FIG. 3, a user operation (an operation for matching a position of a cursor with a predetermined observation section, an operation for matching a position of a cursor with a predetermined observation section and making a click, an operation for touching a predetermined observation section, or the like) for specifying one observation section A, information (text data, image data, or the like) indicating a situation of an observation section A specified according to the operation.

In addition, the output unit 14 may present section information to a previously-registered user. For example, transmission by mail, display on a page after login to an application or a web page, push notification of an application, and the like are exemplified without limitation thereto.

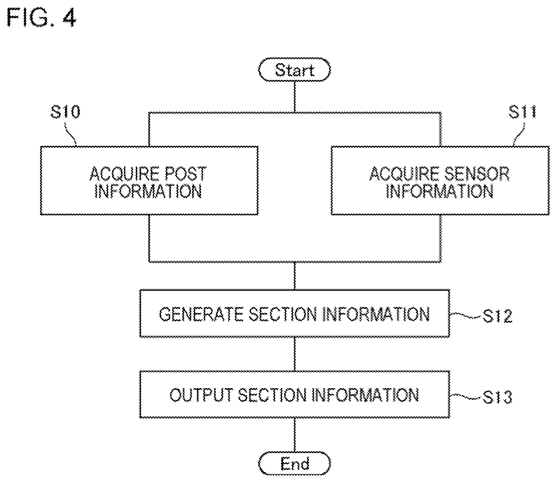

Next, by using a flowchart in FIG. 4, one example of a flow of processing of the information providing apparatus 10 is described.

The post-information acquisition unit 11 acquires post information including a post content posted on the Internet and position information (S10). Further, the sensor-information acquisition unit 12 acquires sensor information including data generated by a sensor and installation position information of the sensor (S11). S10 and S11 may be executed in parallel, or may be executed sequentially in any order.

The section-information generation unit 13 generates, based on the post information acquired in S10 and the sensor information acquired in S11, section information relating to each of a plurality of observation sections (S12). Then, the output unit 14 outputs the section information generated in S12 (S13).

S10 to S13 may be executed based on real time processing, or may be executed based on batch processing. When a congestion situation, a degree of danger in heat illness, or the like of each observation section is generated and output as section information, real time processing is preferable. When a prediction result of a future congestion situation of each observation section is generated and output as section information, real time processing is employable and batch processing is also employable.

### “Advantageous Effect”

The information providing apparatus according to the present example embodiment acquires, as information related to a community, “a post content posted on the Internet” and “data generated by a sensor installed in the community”. Then, the information providing apparatus generates new information by combining the acquired post content and sensor data, and outputs the generated information to a user.

When only acquired information is merely output to a user as acquired, an amount of information being possible to be output is limited to an amount of acquired information. In contrast, when a plurality of types of information are acquired and new information is generated by combining these pieces of information, information can be output beyond an amount of acquired information. For example, a situation of a position undetectable by a sensor is predicted based on data of a peripheral sensor and post information, and thereby information of a position undetectable by a sensor can be complemented. As a result, information of every place in a community can be disclosed. Further, a situation of a position undetectable by a sensor is predicted based on a plurality of pieces of information such as data of a peripheral sensor and post information, and thereby information with higher reliability can be complemented. As a result, information excellent in not only amount but also quality is provided, and thereby a degree of satisfaction of a user can be increased.

### <Second Example Embodiment>

An information providing apparatus 10 according to the present example embodiment sets, as illustrated in FIG. 3 in the above-described observation section setting example 1, a plurality of observation sections A, and then generates and outputs section information indicating a congestion situation of each observation section A. Hereinafter, description thereof is made in detail.

A sensor-information acquisition unit 12 acquires, as sensor information, an image generated by a camera.

A post-information acquisition unit 11 acquires post information indicating at least one of a position of a contributor and a destination to be headed to from now.

The section-information generation unit 13 generates, based on an analysis result of an image and post information, section information indicating a congestion situation in each of a plurality of observation sections. Hereinafter, processing of generating section information is described in detail.

The section-information generation unit 13 can estimate, based on the following computational equation, the number of persons in an observation section.

(The number of persons in a first observation section at a time t)=(the number of persons in the first observation section at a time t−1)+(the number of persons flowing in the first observation section at a timing changed from the time t−1 to the time t)−(the number of persons flowing away from the first observation section at a timing changed from the time t−1 to the time t)

The section-information generation unit 13 may input a computed number of persons to an output unit 14 as section information indicating a congestion situation of each observation section. Then, the output unit 14 may output, as section information indicating a congestion situation of each observation section, a computed number of persons of each observation section.

In addition, the section-information generation unit 13 may convert, based on a predetermined rule, a computed number of persons to another index, and input the converted index to the output unit 14 as section information indicating a congestion situation of each observation section. Then, the output unit 14 may output, as section information indicating a congestion situation of each observation section, the input index of each observation section. A conversion rule is exemplified as, but not limited to, for example, “the number of persons is less than X1: vacant, the number of persons is equal to or more than X1 and less than X2: slightly congested, the number of persons is equal to or more than X2 and less than X3: congested, and the number of persons is equal to or more than X3: very congested”, and the like.

Herein, a computation example of each element of the computational equation is described.

—Computation Example of the Number of Persons Flowing in Each Observation Section and the Number of Persons Flowing Away from Each Observation Section—

After the section-information generation unit 13 computes, based on sensor information and post information each, the number of inflow persons and the number of outflow persons in each observation section, the section-information generation unit 13 integrates the computed numbers, and computes the number of inflow persons and the number of outflow persons in each observation section.

First, processing of computing, based on sensor information, the number of inflow persons and the number of outflow persons is described. The section-information generation unit 13 analyzes an image in a community to be observed acquired by the sensor-information acquisition unit 12, detects a person in the mage, and computes a movement direction and movement velocity of each of the detected persons. Then, the section-information generation unit 13 computes, based on a computation result, the number of inflow persons and the number of outflow persons of each observation section at each timing.

In addition, a sensor such as a beacon is installed, a movement direction/velocity of each user is computed based on a passing time and a passing order at a beacon installation position, and thereby the number of inflow persons and the number of outflow persons of each observation section may be computed based on the computation result. Further, the number of units connected to a base station of mobile phones and the like and a radio field intensity are acquired, and thereby the number of persons present in each observation section may be computed based on these pieces of information. Further, based on a past study result of a traffic study and the like, a trend of the number of inflow persons and the number of outflow persons between observation sections in a season and at a time in the study may be used. Further, an image generated by a camera mounted on a mobile terminal (a smartphone, a mobile phone, or the like) held by a person present in an observation section is acquired based on any manner, the image is analyzed, and thereby it may be possible to detect a person, compute a movement direction and movement velocity, and compute the number of inflow persons and the number of outflow persons of each observation section. In this case, images acquired from a plurality of users may be used by combining the images (by complementing a dead angle to each other).

Next, processing of computing based on post information is described. First, the section-information generation unit 13 estimates, based on the post information, a future movement path of a contributor. The section-information generation unit 13 retrieves, for example, based on a position of a contributor included in the post information and a destination to be headed to from now, a path from the position of the contributor to the destination, and estimates the retrieved result as a future movement path of the contributor. Path retrieval can be achieved by using a known method. Note that, in a sightseeing area, a shopping street, and the like, a movement track of a person therein may be patterned. In this case, the section-information generation unit 13 may estimate, based on the patterned movement track of a person, a future movement path of a contributor. Specifically, the section-information generation unit 13 estimates that a contributor moves by following the movement track.

Then, the section-information generation unit 13 determines, based on a position of a contributor and a time of that time and the above-described estimated movement path, an observation section where a contributor is present at each timing. Then, the section-information generation unit 13 computes, based on the determination result, the number of inflow persons and the number of outflow persons of each observation section at each timing.

Note that, the section-information generation unit 13 may estimate, based on a post content of a contributor, the number of accompanying persons of the contributor. The section-information generation unit 13, for example, analyzes wording of text data acquired as a post content or analyzes a posted image, and thereby may estimate the number of accompanying persons. Then, the section-information generation unit 13 may add the number of accompanying persons in computation of the number of inflow persons and the number of outflow persons of each observation section, based on a movement track of a contributor. In other words, when estimating that a first contributor moves from a first observation section to a second observation section at a first timing and also estimating that there are two accompanying persons of the first contributor, the number of persons moving from the first observation section to the second observation section at the first timing is increased by “3”, based on the information of the first contributor.

Next, processing of integrating the number of inflow persons and the number of outflow persons of each observation section computed based on sensor information and the number of inflow persons and the number of outflow persons of each observation section computed based on post information, and computing the number of inflow persons and the number of outflow persons of each observation section is described.

The section-information generation unit 13 adds, for example, the numbers of inflow persons of each observation section computed based on sensor information and post information each, and thereby may compute the number of inflow persons in each observation section. In addition, the section-information generation unit 13 adds values acquired by multiplying each of the numbers of inflow persons of each observation section computed based on sensor information and post information each with a predetermined weight coefficient, and thereby may compute the number of inflow persons of each observation section. Then, the section-information generation unit 13 may compute, similarly to the above description, the number of outflow persons of each observation section. Note that, a value computed based on the above-described computation method may not always be matched with an actual number of inflow persons and an actual number of outflow persons of each observation section. However, a value to an extent that a guide for a congestion situation can be estimated with sufficient accuracy can be acquired.

### —Computation Example of the Number of Persons in Each Observation Section at a Time 0—

When the number of persons in each observation section is estimated based on the above-described computational equation, it is necessary to estimate the number of persons in each observation section at a time 0. Hereinafter, a specific example is described. Note that herein, it is satisfactory to be possible to acquire a value to an extent that a guide for a congestion situation can be estimated with sufficient accuracy, and a computed value may not necessarily be an accurate value.

### —Computation Example 1—

The section-information generation unit 13 analyzes an image at a time 0 acquired by image-capturing an inside of each observation section, detects a person, and counts the number of the detected persons, and thereby can compute the number of persons in each observation section at the time 0. The example is applicable to an observation section where a camera is installed.

### —Computation Example 2—

Even when a camera is installed, an image may not always be generated in such a way as to include all areas in an observation section. In this case, accuracy of a result acquired in the computation example 1 is insufficient. Therefore, the section-information generation unit 13 integrates a value acquired in the computation expression 1 and a value computed based on post information, and thereby computes a value with higher accuracy.

Herein, processing of computing, based on post information, the number of persons in each observation section at a time 0 is described. First, the section-information generation unit 13 determines, based on the post information, a position of a contributor at a time 0. Note that, metadata of a post content are used, and thereby a position of a contributor can be determined with finer granularity, but when a position of a contributor is determined based on a content (e.g., “Shibuya now” and “now, ∘∘ park) of a post content, granularity of the position is large. The section-information generation unit 13 uses information of more contributors, and therefore determines a position of a contributor in a relatively wide area (a geographical name, a facility name, or the like). In other words, the section-information generation unit 13 determines in what area a contributor is present. Each area includes a plurality of observation sections. Based on the processing, the section-information generation unit 13 can compute a congestion situation (the number of staying persons) of each area.

Note that, the section-information generation unit 13 may estimate, based on a post content of a contributor, the number of accompanying persons of the contributor. The section-information generation unit 13, for example, analyzes wording of text data acquired as a post content and analyzes a posted image, and thereby may estimate the number of accompanying persons. Then, the section-information generation unit 13 may add the number of accompanying persons in computation of the number of staying persons of each area at each timing.

In addition, the section-information generation unit 13 may analyze a posted image and compute the number of persons captured in the image. Then, the section-information generation unit 13 may further add the number of persons captured in the image in computation of the number of staying persons of each area at each timing.

The section-information generation unit 13 computes, after computing, by the above-described processing, a congestion situation (the number of staying persons) of each area, based on the computed congestion situation (the computed number of staying persons) of each area, a congestion situation (the number of staying persons) of each of a plurality of observation sections included in each area. The section-information generation unit 13 may equally allocate, for example, the number of staying persons of each area to a plurality of observation sections included in each area. In addition, the section-information generation unit 13 may prorate, based on a proration coefficient set for each of a plurality of observation sections, the number of staying persons of each area to a plurality of observation sections included in each area.

Next, processing of integrating the number of persons in each observation section at a time 0 computed based on sensor information and the number of persons in each observation section at the time 0 computed based on post information, and computing the number of persons in each observation section at the time 0 is described.

The section-information generation unit 13 adds, for example, the numbers of persons in each observation section at a time 0 computed based on sensor information and post information each, and thereby may compute the number of persons in each observation section at the time 0. In addition, the section-information generation unit 13 adds values acquired by multiplying each of the numbers of persons in each observation section at the time 0 computed based on sensor information and post information each with a predetermined weight coefficient, and thereby may compute the number of persons in each observation section at the time 0.

### —Computation Example 3—

The section-information generation unit 13 integrates a value acquired in the computation example 1 and a value computed based on another piece of information, and thereby computes a value with higher accuracy.

Another piece of information is a tendency of the number (per time zone) of persons present in a predetermined area previously acquired by any manner. Based on any statistical manner, relevant data are generated and provided to the information providing apparatus10. Note that, each area includes a plurality of observation sections.

Then, the section-information generation unit 13 equally allocates the number of staying persons of each area at a time 0 to a plurality of observation sections included in the each area, and thereby computes the number of staying persons of each of a plurality of observation sections. In addition, the section-information generation unit 13 prorates, based on a proration coefficient set for each of a plurality of observation sections, the number of staying persons of each area in each time zone to a plurality of observation sections included in the each area, and thereby may compute the number of staying persons of each of a plurality of observation sections.

Next, processing of integrating the number of persons in each observation section at a time 0 computed based on sensor information and the number of persons in each observation section at the time 0 computed based on the another piece of information, and computing the number of persons in each observation section at the time 0 is described.

The section-information generation unit 13 adds, for example, the numbers of persons in each observation section at a time 0 computed based on sensor information and another piece of information each, and thereby may compute the number of persons in each observation section at the time 0. In addition, the section-information generation unit 13 adds values acquired by multiplying each of the numbers of persons in each observation section at a time 0 computed based on sensor information and another piece of information each with a predetermined weight coefficient, and thereby may compute the number of persons in each observation section at the time 0.

### —Computation Example 4—

The section-information generation unit 13 integrates a value acquired in the computation example 1 and a value computed based on another piece of information, and thereby computes a value with higher accuracy.

Another piece of information is the number (per time zone) of persons present in a predetermined area predicted based on event information on a relevant day. Based on a past result and the like, relevant data are generated and provided to the information providing apparatus 10. Note that, each area includes a plurality of observation sections.

Then, the section-information generation unit 13 equally allocates the number of staying persons of each area at a time 0 to a plurality of observation sections included in the each area, and thereby computes the number of staying persons of each of a plurality of observation sections. In addition, the section-information generation unit 13 prorates, based on a proration coefficient set for each of a plurality of observation sections, the number of staying persons of each area in each time zone to a plurality of observation sections included in the each area, and thereby may compute the number of staying persons of each of a plurality of observation sections.

Next, processing of integrating the number of persons in each observation section at a time 0 computed based on sensor information and the number of persons in each observation section at the time 0 computed based on the another piece of information, and computing the number of persons in each observation section at the time 0 is described.

The section-information generation unit 13 adds, for example, the numbers of persons in each observation section at a time 0 computed based on sensor information and another piece of information each, and thereby may compute the number of persons in each observation section at the time 0. In addition, the section-information generation unit 13 adds values acquired by multiplying each of the numbers of persons in each observation section at a time 0 computed based on sensor information and another piece of information each with a predetermined weight coefficient, and thereby may compute the number of persons in each observation section at the time 0.

### —Computation Example 5—

The section-information generation unit 13 integrates a value acquired in the computation example 1, the number of persons in each observation section at a time 0 computed based on post information, and the number of persons in each observation section at the time 0 computed based on another piece of information, and thereby computes a value with higher accuracy.

Processing of computing, based on post information, the number of persons in each observation section at a time 0 is as described in the computation example 2. Processing of computing, based on another piece of information. the number of persons in each observation section at a time 0 is as described in the computation examples 3 and 4.

Next, processing of integrating the number of persons in each observation section at a time 0 computed based on sensor information, the number of persons in each observation section at the time 0 computed based on post information, and the number of persons in each observation section at the time 0 computed based on another piece of information, and computing the number of persons in each observation section at the time 0 is described.

The section-information generation unit 13 adds, for example, the numbers of persons in each observation section at a time 0 computed based on sensor information, post information, and another piece of information, and thereby may compute the number of persons in each observation section at the time 0. In addition, the section-information generation unit 13 adds values acquired by multiplying each of the numbers of persons in each observation section at a time 0 computed based on sensor information, post information, and another piece of information each with a predetermined weight coefficient, and thereby may compute the number of persons in each observation section at the time 0.

### —Computation Example 6—

The present example is applied to an observation section where a camera is not installed. In the present example, based on an image of another observation section related to each observation section, the number of persons in each observation section at a time 0 is computed. The section-information generation unit 13 may regard, as the number of persons in each observation section at a time 0, for example, the number (a value computed in the computation example 1) of persons in another observation section at the time 0 computed based on an image of the another observation section. In addition, the section-information generation unit 13 may regard, as the number of persons in each observation section at a time 0, a value acquired by multiplying the number (a value computed in the computation example 1) of persons in another observation section at the time 0 computed based on an image of the another observation section with a predetermined coefficient.

Further, the section-information generation unit 13 may regard, as the number of persons in each observation section at a time 0, a value acquired by correcting, similarly to the computation examples 2 to 5, a value acquired based on the above-described method.

Note that, other configurations of the information providing apparatus 10 according to the present example embodiment are similar to those of the first example embodiment.

Herein, modified examples of the information providing apparatus 10 according to the present example embodiment are described.

### —Modified Example 1—

The information providing apparatus 10 may provide a route retrieval service by using a congestion situation computed as described above. In other words, the information providing apparatus 10 retrieves, when acquiring information indicating a current place and a destination from a user terminal, a path where an observation section having a congestion situation of a predetermined level or more is avoided, and transmits a reply to the user terminal. Path retrieval from a current place to a destination can be achieved by using a known method.

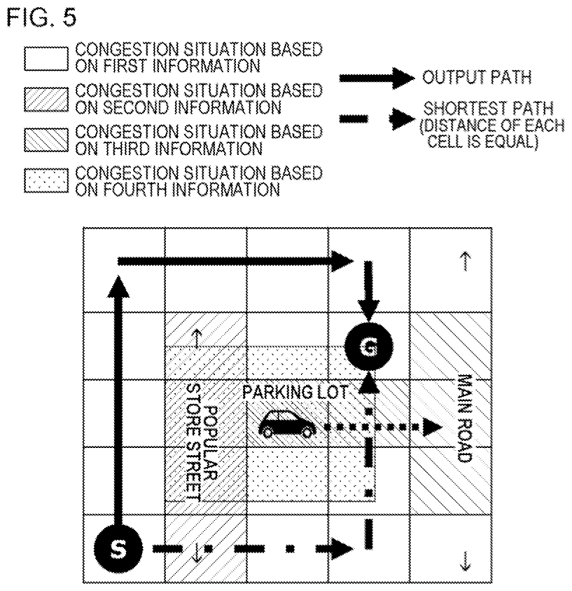

By using FIG. 5, an advantageous effect achieved according to the present modified example is described. Each illustrated cell is relevant to an observation section. Based on each of a plurality of pieces of information (the above-described sensor information, post information, and another piece of information), a congestion situation of each observation section is computed, and a computation result based on each piece of information is mapped on a plurality of cells. Specifically, a cell determined, based on each piece of information, as having a congestion situation of a predetermined level or more is painted with a pattern relevant to each piece of information. A portion having more overlaps based on painting indicates a state of congestion. Note that, the display is one example of an output method for section information based on the output unit 14.

As illustrated, when a current place (an illustrated S) and a destination (an illustrated G) are set, a shortest path indicated by a dashed-dotted arrow passes through a congested observation section. Therefore, the information providing apparatus 10 does not recognize the route as a retrieval result, then retrieves a path which does not pass through an observation section congested as illustrated by a solid arrow in the figure, and outputs the retrieved path.

### —Modified Example 2—

The information providing apparatus 10 may determine, when acquiring information indicating a current place from a user terminal, whether a congestion situation of the current place is at a predetermined level or more. Then, when the congestion situation of the current place is at the predetermined level or more, the information providing apparatus 10 may reply, to the user terminal, a notification for encouragement to move to another place by presenting a predetermined incentive. The notification may be executed based on a method (push notification of an application, an electronic mail, or the like) via a terminal held by a user.

While a content of an incentive is not specifically limited, the information providing apparatus 10 may differentiate a content of an incentive presented according to an attribute of a user. Note that, an attribute of a user is previously registered in the information providing apparatus 10. Then, the information providing apparatus 10 can determine, for example, based on login information (a user identifier (ID) or the like) received from a user terminal, a user of each user terminal and an attribute.

In this case, the information providing apparatus 10 can provide, when confirming a movement to another place within a predetermined time from the above-described notification, a predetermined incentive to the user. The information providing apparatus 10 can confirm a presence or absence of the above-described movement, for example, based on information indicating a current place received from a user terminal.

### —Modified Example 3—

The section-information generation unit 13 acquires, based on any manner, probe information (a traffic volume, velocity, and the like) installed in an automobile and on a road, path information to a destination installed in a car navigation system, and the like, and computes, based on these pieces of information, the number of persons flowing in each observation section, the number of persons flowing away from each observation section, and the number of persons in each observation section at a time 0. Then, by using a method similar to the above, the computed numbers of persons are integrated with values computed based on sensor information, post information, and the like.

### —Modified Example 4—

The section-information generation unit 13 computes, based on information indicating a current position of a user, acceleration information, and the like acquired from a beacon installed in a town and a user terminal, the number of persons flowing in each observation section, the number of persons flowing away from each observation section, and the number of persons in each observation section at a time 0. Then, by using a method similar to the above, the computed numbers of persons are integrated with values computed based on sensor information, post information, and the like.

As described above, according to the information providing apparatus 10 of the present example embodiment, an advantageous effect similar to that of the first example embodiment can be achieved. Further, according to the information providing apparatus 10 of the present example embodiment, a congestion situation of a community to be observed can be recognized in detail.

### <Third Example Embodiment>

An information providing apparatus 10 according to the present example embodiment sets, as illustrated in FIG. 3 in the above-described observation section setting example 1, a plurality of observation sections A, and then generates and outputs section information indicating a degree of danger in heat illness of each observation section A. Hereinafter, description thereof is made in detail.

A sensor-information acquisition unit 12 acquires, as sensor information, at least one of an image generated by a camera, temperature data generated by a temperature sensor, humidity data generated by a humidity sensor, illuminance data generated by an illuminance sensor, wind velocity data generated by a wind velocity sensor, and data indicating an operation status of an air conditioner generated by a surveillance sensor.

A section-information generation unit 13 generates, based on a hotness situation indicated by sensor information and a post content, section information indicating a degree of danger in heat illness of each of a plurality of observation sections. Hereinafter, processing of generating section information is described in detail.

The section-information generation unit 13 can compute, based on the following computational equation, a degree of danger in heat illness of an observation section.

(Degree of danger in heat illness [° C.])=(a hotness index [° C.])+(a correction index [° C.])

An output unit 14 may output, as section information indicating a degree of danger in heat illness of each observation section, a value of each observation section computed by the equation.

In addition, the section-information generation unit 13 may convert, based on a predetermined rule, a value computed by the equation to another index, and input the converted index to the output unit 14 as section information indicating a degree of danger in heat illness of each observation section. Then, the output unit 14 may output, as section information indicating a degree of danger in heat illness of each observation section, the computed index of each observation section. A conversion rule is exemplified as, but not limited to, for example, “a degree of danger in heat illness is less than Y1 [° C.]: safe, a degree of danger in heat illness is equal to or more than Y1 [° C.] and less than Y2 [° C.]: slightly dangerous, a degree of danger in heat illness is equal to or more than Y2 [° C.] and less than Y3 [° C.]: dangerous, and a degree of danger in heat illness is equal to or more than Y3 [° C.]: very dangerous”.

Herein, a computation example of each element of the computational equation is described.

### —Computation Example of a Hotness Index—

The section-information generation unit 13 can compute a hotness index, based on a method disclosed in Non-Patent Documents 1 and 2. In an observation section where a sensor is installed, a hotness index can be computed based on sensor information generated by the sensor. In an observation section where a sensor is not installed, a hotness index can be computed based on sensor information generated by a sensor of another observation section related to each observation section. A unit of a hotness index is “° C.”, and as a value of the index is larger, a degree of danger in heat illness is higher.

### —Computation Example of a Correction Index—

The section-information generation unit 13 can compute a correction index, based on an image (sensor information) or post information. In addition, the section-information generation unit 13 computes correction indexes, based on an image (sensor information) and post information each, and can compute a correction index by adding the computed indexes. A unit of a correction index is “° C.”, and as a value of the index is larger, a degree of danger in heat illness is higher.

### —Example of Computing, Based on an Image, a Correction Index—

The section-information generation unit 13 analyzes an image acquired by image-capturing each observation section and detects features of a behavior, a motion, and an appearance of a person observed when it is hot. Features of a motion and an appearance to be observed are exemplified as, but not limited to, a behavior for producing wind with a hand or a thing, a behavior for wiping sweat, unsteadiness, an exhausted state, a face in pale, a face in bright red, sweating at a predetermined level or more, and the like. The section-information generation unit 13 counts, with respect to each observation section and each predetermined unit time (e.g., five minutes each, ten minutes each, thirty minutes each, or one hour each), the number of detections or the number of persons detected based on the above-described behavior and the like. Then, the section-information generation unit 13 computes. based on the number of counts and a predetermined computational expression, a correction index for each observation section and each unit time. Details of the computational expression are a design matter and are defined in such a way that, as the number of counts is larger, a correction index is larger. Further, the section-information generation unit 13 may execute the above-described counting with respect to each of detected features of a motion and an appearance, and compute, based on a produce between the number of counts and a weighting value (a weighting value according to detected features of a motion and an appearance) and a predetermined computational expression, a correction index for each observation section and each unit time. For a lower degree of seriousness such as a behavior for wiping sweat, a weighting value is smaller, and for a higher degree of seriousness such as unsteadiness, a weighting value is larger.

Note that, the section-information generation unit 13 can compute, in an observation section where an image is not generated, as a correction index of the observation section, a correction index computed based on an image of another observation section related to each observation section or a value acquired by multiplying a value of the index with a predetermined coefficient.

### —Example of Computing, Based on Post Information, a Correction Index—

The section-information generation unit 13 determines, based on post information, a position of a contributor. Specifically, the section-information generation unit 13 determines in what area a contributor is present. Each area includes a plurality of observation sections. The area has been described according to the second example embodiment, and therefore description thereof is omitted herein.

Further, the section-information generation unit 13 analyzes wording of text data acquired as a post content and extracts a word relating to hotness. A word to be extracted is exemplified as, but not limited to, for example, “hot”, “excessively hot”, “feel dizzy”, and the like. Then, the section-information generation unit 13 counts, with respect to each area and each predetermined unit time (e.g., five minutes each, ten minutes each, thirty minutes each, or one hour each), the number of extractions of the above-described word from a post content posted in each area. Then, the section-information generation unit 13 computes a correction index, based on the number of counts and a predetermined computational expression. Note that, details of the computational expression are a design matter and are defined in such a way that, as the number of counts is larger, a correction index is larger. The correction index is applied to all observation sections included in an area.

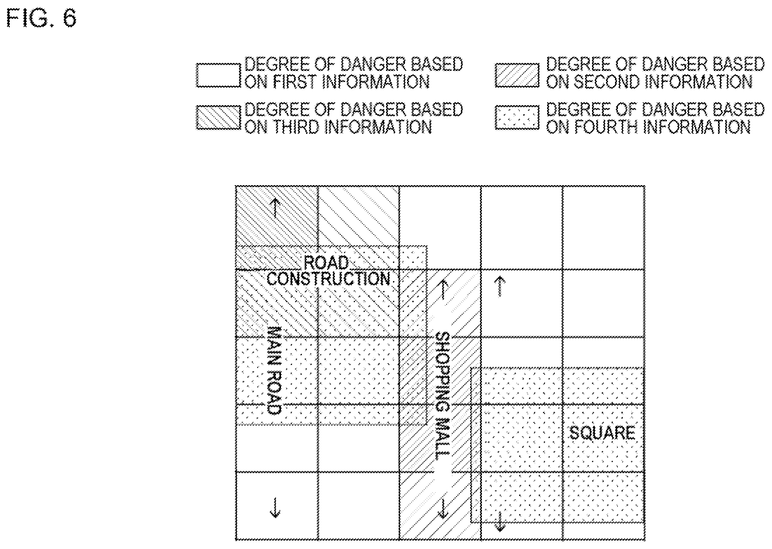

Next, by using FIG. 6, one example of information output by the output unit 14 is described. Each illustrated cell is relevant to an observation section. Based on each of a plurality of pieces of information (the above-described sensor information, post information, and another piece of information), a degree of danger in heat illness of each observation section is computed, and a computation result based on each piece of information is mapped on a plurality of cells. Specifically, a cell determined, based on each piece of information, as having a degree of danger in heat illness of a predetermined level or more is painted with a pattern relevant to each piece of information. A portion having more overlaps based on painting indicates that a degree of danger in heat illness is higher.

Note that, other configurations of the information providing apparatus 10 according to the present example embodiment are similar to those of the first example embodiment.

Herein, modified examples of the information providing apparatus 10 according to the present example embodiment are described.

### —Modified Example 1—

The section-information generation unit 13 determines, based on an image analysis, a behavior content and clothing of each of persons detected in an image, and computes, based on the determination result, a degree of danger in heat illness for each detected person. Specifically, the section-information generation unit 13 adds a degree of danger in heat illness, computed by the above-described method, of an observation section where the person is present with a value computed according to a behavior and clothing of each of detected persons, and computes a degree of danger in heat illness for each person. The correction method is disclosed in Non-Patent Document 3. For clothing (a hat is not worn, thick clothing is worn, and the like) increasing a degree of danger in heat illness, a value to be added is larger. Further, for a movement (heavy exercise, manual labor, and the like) increasing a degree of danger in heat illness, a value to be added is larger.

The output unit 14 issues, when a detected degree of danger in heat illness of a person is equal to or more than a predetermined level, a warning to the person.

When, for example, a configuration is made in such a way that face information (a feature value of an appearance) of a user (a user receiving a relevant warning service of the information providing apparatus 10) is previously registered (when the warning service is designed in such a way), the information providing apparatus 10 may determine, by using a face recognition technique or the like, whether a person detected in an image is a previously-registered user. Then, when a person detected in an image is a previously-registered user, the output unit 14 may achieve, based on a method (push notification of an application, an electronic mail, or the like) via a terminal held by a user, a warning to the user.

In addition, the output unit 14 may output warning information via an output apparatus (a speaker, a display, or the like) installed in a vicinity of a place where a person as a warning target is present.

In addition, the output unit 14 may notify a predetermined notification partner of a person having a degree of danger in heat illness of a predetermined level or more. The predetermined notification partner includes an administrator of a community to be observed, a patrol staff member, a security staff member, and the like. A notification content may include an image, an attribute, a present position, a degree of danger in heat illness, and the like of a person having a degree of danger in heat illness of a predetermined level or more. The output unit 14 may achieve, based on a method (push notification of an application, an electronic mail, or the like) via a terminal held by a predetermined notification partner, a notification to the predetermined notification partner.

Note that, the output unit 14 may issue, when determining that a registered user is present in a section where a degree of danger in heat illness indicates a fixed value or more, a warning to a terminal held by the user. Then, a warning to be notified may include display of a map indicating a situation of an observation section as in FIG. 6.

### —Modified Example 2—

When an observation section where a degree of danger in heat illness is a predetermined level or more is present, the output unit 14 issues a notification of the fact to an administrator of a community to be observed including the observation section and a previously-registered user. The notification may be executed based on a method (push notification of an application, an electronic mail, or the like) via a terminal held by a user. In addition, the information providing apparatus 10 may post information indicating the fact to a predetermined SNS site and a social media site.

### —Modified Example 3—

The section-information generation unit 13 may generate the above-described correction index with respect to each group where an attribute (gender or age) is similar. In other words, the section-information generation unit 13 analyzes an image, detects an attribute of a person detected from the image, and counts, with respect to each group where an attribute is similar, “the number of detections or the number of persons detected based on the above-described behavior or the like” as described above. Then, the section-information generation unit 13 computes, based on the number of counts for each group, a correction index with respect to each group.

Further, the section-information generation unit 13 determines, from account information of a contributor, an attribute of the contributor. Then, the section-information generation unit 13 counts, with respect to each group where an attribute is similar, “the number of extractions of a predetermined keyword” as described above. Then, the section-information generation unit 13 computes, based on the number of counts for each group, a correction index with respect to each group.

Then, the section-information generation unit 13 integrates, based on a method similar to the above-described method, correction indexes for each group generated based on sensor information and post information each. In a case of this example, the section-information generation unit 13 computes, with respect to each group where an attribute is similar, a degree of danger in heat illness. Then, the output unit 14 outputs a degree of danger in heat illness for each group.

### —Modified Example 4—

The section-information generation unit 13 determines, based on previously-registered information, an area where a predetermined event is performed, and adds a predetermined correction index according to holding of an event to a degree of danger [° C.] in heat illness of an observation section included in the area.

### —Modified Example 5—

The section-information generation unit 13 computes, based on data indicating an operation status of an air conditioner generated by a surveillance sensor in an observation section, a correction index to be added to a degree of danger [° C.] in heat illness of the observation section. When an operation status of an air conditioner is a reference level or less while a temperature or humidity outside a building where the air conditioner is installed is equal or more than a reference value, a degree of danger in heat illness in the building increases. Therefore, in such a case, the section-information generation unit 13 determines a correction index having a value larger than 0. The section-information generation unit 13 determines a larger correction index as a temperature or humidity outside a building is higher and an operation status of an air conditioner is lower (a set temperature is higher, an air volume is weaker, and the like).

### —Modified Example 6—

The section-information generation unit 13 computes, based on data indicating an operation status of an air conditioner generated by a surveillance sensor, a correction index to be added to a degree of danger [° C.] in heat illness of an observation section (external space) adjacent to a building where the air conditioner is installed. A degree of danger in heat illness of an observation section adjacent to a building where an air conditioner is installed increases due to heat generated by operating the air conditioner as an operation of the air conditioner increases. Therefore, the section-information generation unit 13 determines a larger correction index as an operation status of an air conditioner is higher (a set temperature is lower, an air volume is stronger, and the like).

### —Modified Example 7—

The section-information generation unit 13 analyzes an image, computes a ratio of shade inside an observation section, and computes a correction index to be added to a degree of danger [° C.] in heat illness of the observation section according to the ratio. The section-information generation unit 13 determines, when a ratio of shade is equal to or less than a reference value, a correction index having a value larger than 0. Then, the section-information generation unit 13 determines a larger correction index as a ratio of shade is smaller.

Note that, in an observation section where an image is not generated, a correction index computed based on an image of another observation section related to each observation section or a value acquired by multiplying a value of the index with a predetermined coefficient can be computed as a correction index of the observation section. By considering that a direction of shade changes in each time zone, a predetermined coefficient may be different for each time zone.

### —Modified Example 8—

The section-information generation unit 13 computes, based on at least one of humidity data generated by a humidity sensor, illuminance data generated by an illuminance sensor, and wind velocity data generated by a wind velocity sensor, a correction index to be added to a degree of danger [° C.] in heat illness of each observation section. The section-information generation unit 13 determines, when at least one of a fact that humidity has a value equal to or larger than a reference value, a fact that illuminance has a value equal to or larger than a reference value, and a fact that wind velocity has a value equal to or less than a reference value is satisfied, a correction index having a value larger than 0. Then, the section-information generation unit 13 determines a larger correction index as humidity is higher, illuminance is higher, or wind velocity is lower.

Note that, in an observation section where these pieces of sensor information are not generated, a correction index computed based on sensor information of another observation section related to each observation section or a value acquired by multiplying a value of the index with a predetermined coefficient can be computed as a correction index of the observation section.

### —Modified Example 9—

According to the present modified example, the information providing apparatus 10 can remotely operate a hotness control apparatus such as an air conditioner or a mist apparatus installed in a community to be observed. Then, the output unit 14 operates a hotness control apparatus installed in an observation section where a degree of danger in heat illness is a predetermined level or more or a hotness control apparatus installed in a periphery of the observation section (at a predetermined distance or less from the observation section).

As described above, according to the information providing apparatus 10 of the present example embodiment, an advantageous effect similar to that of the first example embodiment is achieved. Further, according to the information providing apparatus 10 of the present example embodiment, a degree of danger in heat illness of an observation target can be recognized in detail.

### <Fourth Example Embodiment>

An information providing apparatus 10 according to the present example embodiment sets an observation section in a facility (a store, a station, or the like) unit existing in a community to be observed in the above-described observation section setting example 2, and generates and outputs section information indicating a future congestion situation of each observation section. Hereinafter, description thereof is made in detail.

A sensor-information acquisition unit 12 acquires, as sensor information, an image generated by a camera.

A section-information generation unit 13 generates, based on a congestion situation of a position related to a facility to be observed estimated based on an image and a degree of association between a fashion product determined by a post content and a facility to be observed, section information indicating a future congestion situation of the facility to be observed. Hereinafter, processing of generating section information is described in detail.

The section-information generation unit 13 can estimate, based on the following computational equation, a future congestion situation of a facility to be observed.

(A predicted number of visitors)=(a degree of association with a fashion product)×(a congestion situation of a position related to a facility to be observed/the number of competing facilities)/(1/a coefficient according to a distance from a congested spot)×(a coefficient based on an average number of store visitors)

The section-information generation unit 13 may input a computed predicted number of visitors to an output unit 14 as section information indicating a future congestion situation of each observation section. Then, the output unit 14 may notify each facility of the input section information (the predicted number of visitors) of each observation section.

In addition, the section-information generation unit 13 may convert, based on a predetermined rule, a computed predicted number of visitors to another index, and input the converted index to the output unit 14 as section information indicating a future congestion situation of each observation section. Then, the output unit 14 may notify each facility of the input section information (converted index) of each observation section. A conversion rule is exemplified as, but not limited to, for example, “the number of persons is less than X1: vacant, the number of persons is equal to or more than X1 and less than X2: slightly congested, the number of persons is equal to or more than X2 and less than X3: congested, and the number of persons is equal to or more than X3: very congested”, and the like.

The output unit 14 can achieve a notification to each facility by using a manner such as transmission by mail, display on a page after login to an application or a web page, and push notification of an application. Note that, a notification may be a notification to a terminal associated with each facility.

Herein, a computation example of each element of the computational equation is described.

—Computation Example of a Degree of Association with a Fashion Product—

The present degree of association is 1 or 0. The section-information generation unit 13 determines a relevant degree of association of each facility, based on previously-registered information (a business type, a handled product, and the like) of each facility. The section-information generation unit 13, for example, may set, as 1, a relevant degree of association of a facility handling a fashion product, and set, as 0, a relevant degree of association of a facility not handling a fashion product. In addition, the section-information generation unit 13 may set, as 1, a relevant degree of association of a facility falling under a business type handling a fashion product, and set, as 0, a relevant degree of association of a facility falling under a business type not handling a fashion product.

Next, processing of determining a fashion product is described. The section-information generation unit 13 can determine, based on post information, a fashion product. The section-information generation unit 13 analyzes, for example, a post content in a last predetermined period, computes the number of appearances of a word included in the post content, and thereby may determine, as a fashion product, a product indicated by a word in which the number of appearances is equal to or more than a reference value. Note that, the section-information generation unit 13 may analyze only post information including position information related to a community to be observed, compute the number of appearances described above, and determine a fashion product, or may analyze all pieces of post information without being bound by position information and execute the processing.

### —Computation Example of a Congestion Situation of a Position Related to a Facility to be Observed—

The section-information generation unit 13 computes, as a congestion situation of a position related to a facility to be observed, a congestion situation (the number of persons) of an area including a facility to be observed. A congestion situation (the number of persons) of an area including a facility to be observed can be achieved by employing processing of computing a congestion situation (the number of persons) of a predetermined area described according to the second example embodiment. A current congestion situation is estimated, and thereby the number of visitors of each facility after several minutes or several hours can be estimated.

### —Computation Example of the Number of Competing Facilities—

The section-information generation unit 13 determines, based on previously-registered information (a business type, a handled product, and the like) of each facility, the above-described degree of association of each facility with a first fashion product. Then, the section-information generation unit 13 computes, as the number of competing facilities in the first fashion product, the number of facilities where a degree of association is determined as “1”.

—Computation Example of a Coefficient according to a Distance from a Congested Spot”

The section-information generation unit 13 determines a spot where a congestion situation is at a reference level or more in an area including a facility to be observed. Note that, when there are a plurality of spots where a congestion situation is at a reference level or more, the section-information generation unit 13 determines a plurality of spots. The section-information generation unit 13 determines, as a spot where a congestion situation is at a reference level or more, for example, a spot where the number of persons detected from an image generated by each of a plurality of cameras installed in an area is equal to or more than a reference value. Then, the section-information generation unit 13 determines a coefficient according to a distance from the determined spot. The distance can be computed based on previously-registered position information of each facility and installation position information of a camera. A way of determining a coefficient is a design matter, and as a distance is larger, a coefficient is determined in such a way as to be larger.

### —Computation Example of a Coefficient Based on an Average Number of Store Visitors—

The section-information generation unit 13 determines a relevant coefficient of each facility, based on previously-registered information (the number of store visitors computed based on a past result) of each facility. A way of determining a coefficient is a design matter, and for a facility where an average number of store visitors is larger, a coefficient is determined in such a way as to be larger. The section-information generation unit 13 may determine a coefficient of each facility, for example, based on a ratio of an average number of store visitors of each facility to a total number of average numbers of store visitors of a plurality of competing facilities.

Note that, other configurations of the information providing apparatus 10 according to the present example embodiment are similar to those of the first example embodiment.

Herein, a modified example of the information providing apparatus 10 according to the present example embodiment is described.

### —Modified Example 1—

The section-information generation unit 13 estimates a congestion situation in a future (after several hours, on a next day, or the like) as the “congestion situation of a position related to a facility to be observed” described above. Then, the section-information generation unit 13 estimates, based on the “congestion situation of a position related to a facility to be observed”, the number of visitors of each facility in a future (after several hours, on a next day, or the like).

Estimation of a future congestion situation can be achieved by using every technique. For example, by using machine learning based on past result data in which a factor (whether, temperature, humidity, a month, a day of week, a season, a peripheral event, the number of reservations of a facility in an area, the number of persons of the area before several hours, the number of persons of the area on a previous day, and the like) which may affect the number of persons coming to a certain place is associated with the number of persons who actually come, an estimation model for estimating the number of persons coming to the place from the above-described factor is generated, and thereby a prediction may be made based on the estimation model.

As described above, according to the information providing apparatus 10 of the present example embodiment, an advantageous effect similar to that of the first example embodiment is achieved. Further, according to the information providing apparatus 10 of the present example embodiment, a future congestion situation of a facility to be observed can be recognized in detail.

### <Modified Example>

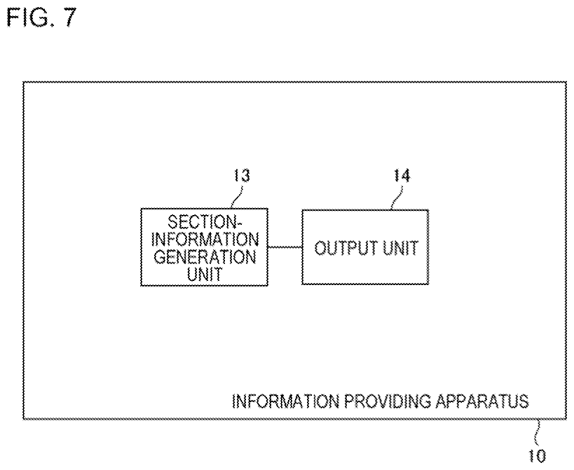

Herein, a modified example of an information providing apparatus 10 is described. FIG. 7 illustrates one example of a function block diagram of the information providing apparatus 10 according to the modified example. As illustrated, the information providing apparatus 10 according to the modified example includes a section-information generation unit 13 and an output unit 14. Then, the information providing apparatus 10 according to the modified example is different from that of the first to fourth example embodiments in that a post-information acquisition unit 11 and a sensor-information acquisition unit 12 are not included. A configuration of each of the section-information generation unit 13 and the output unit 14 is similar to those of the first to fourth example embodiments. Also in the information providing apparatus 10 according to the modified example, an advantageous effect similar to that of the first to fourth example embodiments is achieved.

While as described above, example embodiments according to the present invention have been described, these example embodiments are an exemplification of the present invention, and therefore various configurations other than the above-described configurations can be employable.

Note that, according to the present specification, “acquisition” includes at least any one of a matter that “a local apparatus fetches data stored in another apparatus or a storage medium (active acquisition)”, based on user input or based on an instruction from a program, e.g., a matter that reception is executed by making a request or an inquiry to another apparatus, a matter that reading is executed by accessing another apparatus or a storage medium, and the like; a matter that “data output from another apparatus are input to a local apparatus (passive acquisition)” based on user input or based on an instruction from a program, e.g., a matter that data distributed (or transmitted, reported on a push basis, or the like) are received, and a matter that selective acquisition is executed from among received pieces of data or information; and a matter that “new data are generated by data editing (conversion to text, data rearrangement, partial data extraction, file-format modification, and the like) or the like and the new data are acquired”.

The whole or part of the example embodiments disclosed above can be described as, but not limited to, the following supplementary notes.
1. An information providing apparatus including:

a post-information acquisition means for acquiring post information including a post content posted on the Internet and position information;

a sensor-information acquisition means for acquiring sensor information including data generated by a sensor and installation position information of the sensor;

a section-information generation means for generating, based on the post information and the sensor information, section information relating to each of a plurality of observation sections; and

an output means for outputting the section information.
2. The information providing apparatus according to supplementary note 1, wherein

the output means outputs an image where the section information is mapped on a map.
3. The information providing apparatus according to supplementary note 1 or 2, wherein data generated by the sensor are an image,

the post information indicates at least either of a position of a contributor or a destination to be headed to from now, and

the section-information generation means generates, based on an analysis result of the image and the post information, the section information indicating a congestion situation in each of the plurality of observation sections.
4. The information providing apparatus according to supplementary note 3, wherein

the section-information generation means estimates, based on the image of the observation section where the sensor is installed, the congestion situation of each of the observation sections where the sensor is not installed.
5. The information providing apparatus according to supplementary note 3 or 4, wherein

the section-information generation means estimates, based on the post information, a congestion situation in an area including the plurality of observation sections, and then estimates, based on the estimated congestion situation of the area, a congestion situation of each of the plurality of observation sections.
6. The information providing apparatus according to any one of supplementary notes 3 to 5, wherein

the section-information generation means

estimates, based on the post information, a future movement path of a contributor, and

estimates, based on the estimated movement path, a congestion situation of each of the plurality of observation sections.
7. The information providing apparatus according to supplementary note 1, wherein

the observation section is a facility to be observed,

data generated by the sensor is an image, and

the section-information generation means generates, based on a congestion situation of a position related to the facility to be observed estimated based on the image and a degree of association between a fashion product determined by the post content and the facility to be observed, the section information indicating a future congestion situation of the facility to be observed.
8. The information providing apparatus according to supplementary note 1, wherein

data generated by the sensor include at least one of an image, temperature data, humidity data, illuminance data, wind velocity data, and data indicating an operation status of an air conditioner, and

the section-information generation means generates, based on a hotness situation indicated by the sensor information and the post content, the section information indicating a degree of danger in heat illness of each of the plurality of observation sections.
9. An information providing method including:

by a computer,

acquiring post information including a post content posted on the Internet and position information;

acquiring sensor information including data generated by a sensor and installation position information of the sensor;

generating, based on the post information and the sensor information, section information relating to each of a plurality of observation sections; and

outputting the section information.
10. A program causing a computer to function as:

a post-information acquisition means for acquiring post information including a post content posted on the Internet and position information;

a sensor-information acquisition means for acquiring sensor information including data generated by a sensor and installation position information of the sensor;

a section-information generation means for generating, based on the post information and the sensor information, section information relating to each of a plurality of observation sections; and

an output means for outputting the section information.
11. An information providing apparatus including:

a section-information generation means for generating, based on a post content that includes position information and is posted on the Internet and sensor information including data generated by a sensor and installation position information of the sensor, section information relating to each of a plurality of observation sections; and

an output means for outputting an image where the section information is mapped on a map.
10 Information providing apparatus
11 Post-information acquisition unit
12 Sensor-information acquisition unit
13 Section-information generation unit
14 Output unit
1A Processor
2A Memory

3A Input/output I/F
4A Peripheral circuit
5A Bus

What is claimed is:

1. An information providing apparatus comprising:
at least one memory configured to store one or more instructions; and
at least one processor configured to execute the one or more instructions to:
acquire post information including a post content posted on the Internet and position information;
acquire sensor information including data generated by a sensor and installation position information of the sensor;
generate, based on the post information and the sensor information, section information relating to each of a plurality of observation sections; and
output the section information.

2. The information providing apparatus according to claim 1, wherein
the processor is further configured to execute the one or more instructions to output an image where the section information is mapped on a map.

3. The information providing apparatus according to claim 1, wherein
data generated by the sensor are an image,
the post information indicates at least either of a position of a contributor or a destination to be headed to from now, and
the processor is further configured to execute the one or more instructions to generate, based on an analysis result of the image and the post information, the section information indicating a congestion situation in each of the plurality of observation sections.

4. The information providing apparatus according to claim 3, wherein
the processor is further configured to execute the one or more instructions to estimate, based on the image of the observation section where the sensor is installed, the congestion situation of each of the observation sections where the sensor is not installed.

5. The information providing apparatus according to claim 3, wherein
the processor is further configured to execute the one or more instructions to estimate, based on the post information, a congestion situation in an area including the plurality of observation sections, and then estimate, based on the estimated congestion situation of the area, a congestion situation of each of the plurality of observation sections.

6. The information providing apparatus according to claim 3, wherein
the processor is further configured to execute the one or more instructions to:
estimate, based on the post information, a future movement path of a contributor, and
estimate, based on the estimated movement path, a congestion situation of each of the plurality of observation sections.

7. The information providing apparatus according to claim 1, wherein
the observation section is a facility to be observed,
data generated by the sensor is an image, and
the processor is further configured to execute the one or more instructions to generate, based on a congestion situation of a position related to the facility to be observed estimated based on the image and a degree of association between a fashion product determined by the post content and the facility to be observed, the section information indicating a future congestion situation of the facility to be observed.

8. The information providing apparatus according to claim 1, wherein
data generated by the sensor include at least one of an image, temperature data, humidity data, illuminance data, wind velocity data, and data indicating an operation status of an air conditioner, and
the processor is further configured to execute the one or more instructions to generate, based on a hotness situation indicated by the sensor information and the post content, the section information indicating a degree of danger in heat illness of each of the plurality of observation sections.

9. An information providing method comprising:
by a computer,
acquiring post information including a post content posted on the Internet and position information;
acquiring sensor information including data generated by a sensor and installation position information of the sensor;
generating, based on the post information and the sensor information, section information relating to each of a plurality of observation sections; and
outputting the section information.

10. A non-transitory storage medium storing a program causing a computer to execute each step in the information providing method according to claim 9.

11. An information providing apparatus comprising:
at least one memory configured to store one or more instructions; and
at least one processor configured to execute the one or more instructions to:
generate, based on a post content that includes position information and is posted on the Internet and sensor information including data generated by a sensor and installation position information of the sensor, section information relating to each of a plurality of observation sections; and
output an image where the section information is mapped on a map.
